(19) United States
(12) Patent Application Publication
(10) Pub. No.: US 2008/0109780 A1
(43) Pub. Date: May 8, 2008

(54) METHOD OF AND APPARATUS FOR OPTIMAL PLACEMENT AND VALIDATION OF I/O BLOCKS WITHIN AN ASIC

(75) Inventors: Amir Stern, Raanana (IL); Boaz Yeger, Zichron Ya'akov (IL); Amir Ziv, Nesher (IL)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/551,304

(22) Filed: Oct. 20, 2006

(51) Int. Cl. G06F 17/50

(52) U.S. Cl. 716/11

(57) ABSTRACT

A novel system and procedure for placement and validation of I/O pins within an ASIC package module. The system reads and a plurality of data files containing chip design, technology and package related information. The parsed data is stored in a single I/O assignment information database that functions to store and organize all the data from all chip design, technology and package files. Access to the database is controlled by three sets of keys, with each key in each set being unique. The three sets of keys include: pin name, package pin coordination and Controlled Collapse Chip Connection (C4) on a flip chip area array packaging or IO slot (i e. chip wire bond connection). A dynamic graphical view of the package pins is built using these three keys and the contents of the I/O assignment information database. Users enter pin assignments data and, in response, the system validates the data against a set (of technology constraints and updates the assignment database accordingly.

### FIELD OF THE INVENTION

The present invention relates to the field of computer aided design tools used for integrated circuit design and more particularly relates to a system and procedure for optimizing the placement and validation of input and output (I/O) blocks in an application specific integrated circuit (ASIC).

### BACKGROUND OF THE INVENTION

An integral and necessary, part of designing an ASIC is to bind an I/O book to the chip logic design and assign it to the chip package pins. Currently planning and assigning I/O signals to the IC package pins is performed using complex and hard-to-follow text files. In addition, the assignment work is carried out by personnel having at several levels of expertise. At one level, a logic design engineer responsible for connecting the inner logic to the I/O book. At another level, a package designer is responsible for designing the package and allocating the proper pins in the package. At yet another level, a board or system engineer is responsible for the location and technology of the peripheral interfaces. A,t still another level, a technology engineer is responsible for connecting, the I/O book to the package pins and checking to ensure that the assignment is within the boundary of the limitations of the technology. Moreover, the technology data to accomplish these tasks is spread among several files, each file being used for a particular purpose. Most of the files, however contain duplicate data.

A flow diagram illustrating typical prior art ASIC I/O planning workflow is shown in FIG. 1. One of the first steps taken once the contract between the chip vendor and the customer is signed (step 10), is to select the technology and package type for the IC (step 12). The customer is then trained in the relevant technology and design guidelines of the selected technology (step) 14. Using a vendor supplied design tool kit (step 16), the user (i.e. customer) generates the necessary I/O plan files, i.e. the IOSpecList (step 18). The IOSpecList is a database consisting of one record for each I/O signal with a number of keyword=value pairs that hold information related to the I/O signal.

Several checks and validations must then be performed including: whether the I/O plan obeys the technology) rules (step 20); whether the I/O plan is aligned with the package (step 272); whether the I/O plan obeys the package rules (step 24), whether the I/O plan fits the card design (step 26); and whether the I/O plan is aligned with the chip architecture (step 28). If any of these conditions are not met, the I/O plan files must be modified and the checks performed again. Once all the conditions are met, the I/O plan file is ready, for processing.

The I/O assignment process described above is error prone and tedious. The technology engineer is responsible for assigning the logic signals provided by the logic designers. The I/O assignment is performed according to the I/O data received by the package and board engineers. After the first round of assignment work is completed, however, the technology engineer must check for technology violations and re-assign pains if necessary. Any changes in the technology files, logic design, package or board data results in the technology engineer needing to re-run the technology check and validate the new assignment. Usually this methodology thus typically creates numerous I/O plan iterations. Further changes to I/O signals can continue to occur up until the last minute. These changes are usually caused by misunderstandings between the chip design team and the customer specifications or by an incorrect interpretation of the technology.

There is thus a need for a user friendly GUI based I/O pin assignment design tool that is able to read various I/O technology files (e.g., an image/package cross reference file (xref), Physical Design File (PDL), IO Plan File, Image Design File (IFS), etc.), provide the user with a single, simple easy to use interface for making pin I/O assignments and automatically checks for violation of technology and package rules. In addition, the design tool is preferably a stand-alone application that is capable of executing on multiple platforms.

### SUMMARY OF THE INVENTION

The present invention is a system and procedure for placement and validation of I/O pins within an ASIC package module that overcomes the problems and disadvantages of the prior art. The system reads and parses a plurality of data files containing chip design, technology and package related information. The parsed data is stored in a single I/O assignment information database that functions to store and organize all the data from all chip design technology and package files. Access to the database is controlled by three sets of keys with each key in each set being unique. The three sets of keys include: pin name, package pin coordination and Controlled Collapse Chip Connection (C4) on a flip chip area array packaging or I/O slot (i.e. chip wire bond connection). A dynamic graphical view of the package pins is built using these three keys and the contents of the I/O assignment information database. Users enter pin assignment data and, in responses the system validates the data against a set of technology constraints and updates the assignment database accordingly.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated (Circuit (ASIC) or Field Programmable Gate Array (FPGA), or as functionally equivalent discrete hardware components.

There is thus provided in accordance with the invention a method of placing and validating input/output (I/O) pins in an integrated circuit (IC), the method comprising the steps of receiving IC related data including technology constraints and package and pin data, parsing the IC related data and building, an I/O assignment information database therefrom, building a dynamic graphical view of the package pins based on the contents of the I/O assignment information database and validating pin assignments received from a user against the technology constraints; and updating the I/O assignment information database in accordance therewith.

There is also provided in accordance with the invention a computer program product comprising a computer usable medium having computer usable program code for placing and validating input/output (I/O) pins in an integrated circuit (IC), the computer program product including, computer usable program code for receiving IC related data including technology constraints and package and pin data, computer usable program code for parsing the IC related data and building an I/O assignment information database therefrom, computer usable program code for building a dynamic graphical view of the package pins based on the contents of the I/O assignment information database and computer usable program code for validating pin assignments received from a user against the technology constraints, and updating the I/O assignment information database in accordance therewith.

There is further provided in accordance with the invention a method of placing and validating input/output (I/O) pins in an integrated circuit (IC), the method comprising the steps of receiving package and I/O related data associated with an IC, receiving a set of technology constraints associated with the IC, parsing the IC package and I/O related data and the set of technology constraints and building an I/O assignment information database in accordance therewith, building a dynamic graphical view of the package pins based on the contents of the I/O assignment information database, optimizing the placements of one or more user selected pins, validating pin assignments against the technology constraints; and updating the I/O assignment information database in accordance therewith and redrawing the packet view in accordance with the contents of the updated I/O assignment information on database.

There is also provided in accordance with the invention a computer program product comprising a computer usable medium having computer usable program code for placing and validating input/output (I/O) pins in integrated circuit (IC), the computer program product including, computer usable program code for receiving package and I/O related data associated with an IC, computer usable program code for receiving a set of technology constraints associated with the IC, computer usable program code for parsing the IC package and I/O related data and the set of technology constraints and building an I/O assignment information database in accordance therewith, computer usable program code for building a dynamic graphical view of the package pins based on the contents of the I/O assignment information database, computer usable program code for optimizing the placement of one or more user selected pins, computer usable program code for validating pin assignments against the technology constraints; and updating the I/O assignment information database in accordance therewith and computer usable program code for redrawing the packet view in accordance with the contents of the updated I/O assignment information database.

### BRIEF DESCRIPTION OF THE DRAWINGS

The invention is herein described, by way of example only, with reference to the accompanying drawings, wherein:

FIG. 1 is a flow diagram illustrating typical prior art ASIC I/O planning workflow;

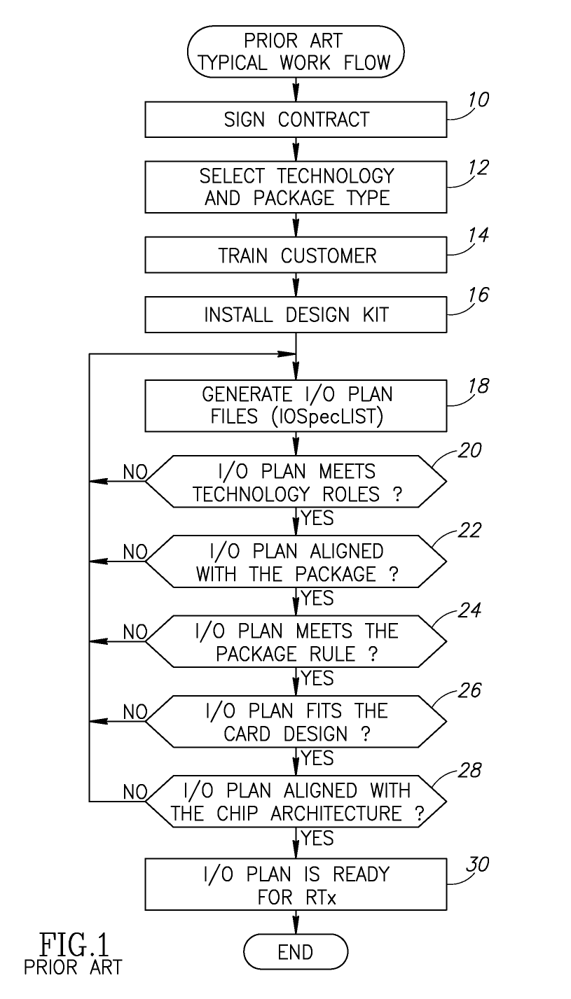

FIG. 2 is a block diagram illustrating an example computer processing system adapted to implement the ASIC I/O pin placement and validation system of the present invention.

FIG. 3 is a diagram illustrating the combining of a plurality of technology files to yield a combined format file in accordance with the present invention;

FIG. 4 is a block diagram illustrating an example embodiment of the I/O pin placement and validation tool of the present invention;

FIG. 5 is a flow diagram illustrating the basic flow of the I/O pin placement and validation tool of the present invention;

FIG. 6 is a diagram illustrating the structure of the assignment information database in more detail;

FIG. 7 is a flow diagram illustrating the I/O file parsing process portion of the I/O pin placement and validation tool of the present invention in more detail;

FIG. 8 is a flow diagram illustrating the I/O assignment window process portion of the I/O pin placement and validation tool as implemented in a software application; and

FIG. 9 is an example screen shot of an example embodiment of the I/O pin placement and validation tool.

### DETAILED DESCRIPTION OF THE INVENTION

The present invention is a system and procedure for placement and validation of I/O pins within an ASIC package module that overcomes the problems and disadvantages of the prior art. The system reads and parses a plurality of data files containing chip design, technology and package related information. The parsed data is stored in a single I/O assignment information database that functions to store and organize all the data from all chip design, technology and package files. Access to the database is controlled by three sets of keys, with each key in each set being unique. The three sets of keys included pin name package pin coordination and Controlled Collapse Chip Connection (C4) on a flip chip area array packaging or I/O slot (i.e. chip wire bond connection). A dynamic graphical view of the package pins is built using these three keys and the contents of the I/O assignment information database. Users enter pin assignment data and, in response, the system validates the data against a set of technology constraints and updates the assignment database accordingly.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be borne in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

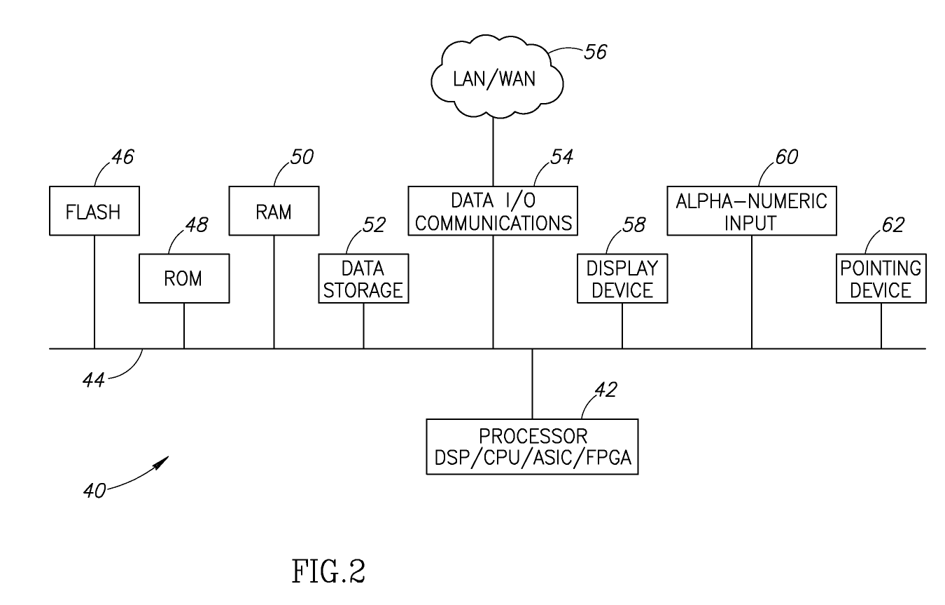

A block diagram illustrating an example computer processing system adapted to implement the ASIC I/O pin placement and validation system of the present invention is shown in FIG. 2. The computer system, generally referenced 40, comprises a processor 42 which may comprise a digital signal processor (DSP), central processing unit (CPU), microcontroller, microprocessor, microcomputer, ASIC or FPGA core. The system also comprises static read only memory 48 and dynamic main memory 50 all in communication with the processor. The processor is also in communication, via bus 44, with a number of peripheral devices that are also included in the computer system. Peripheral devices coupled to the bus include a display device 5-8 (e.g. monitor), alpha-numeric input device 60 (e.g. keyboard) and pointing device 62 (e.g., mouse, tablet, etc.)

The computer system is connected to one or more external networks such as a LAN or WAN 56 via communication lines connected to the system via data I/O communications interface 54 (e.g., network interface card or NIC). The network adapters 54 coupled to the system enable the data processing system to become coupled to other data processing systems or remote printers or storage devices through intervening private or public networks. Modems, cable modem and Ethernet cards are just a few of the currently, available types of network adapters. The system also comprises magnetic or semiconductor based storage device 52 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the I/O pin placement and validation system is adapted to reside on a computer readable medium such as a magnetic disk within a disk drive unit. Alternatively, the computer readable medium may comprise a floppy disk, removable hard disk, Flash memory 46, EEROM based memory, bubble memory storage, ROM storage, distribution media, intermediate storage media, execution memory of a computer, and any other medium or device capable of storing for later reading by a computer a computer program implementing the method of this invention. The software adapted to implement the I/O pin placement and validation system of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the I/O pin placement and validation system of the present invention, and to the extent that a particular system configuration is capable of implementing the system and methods of this invention, it is equivalent to the representative digital computer system of FIG. 2 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

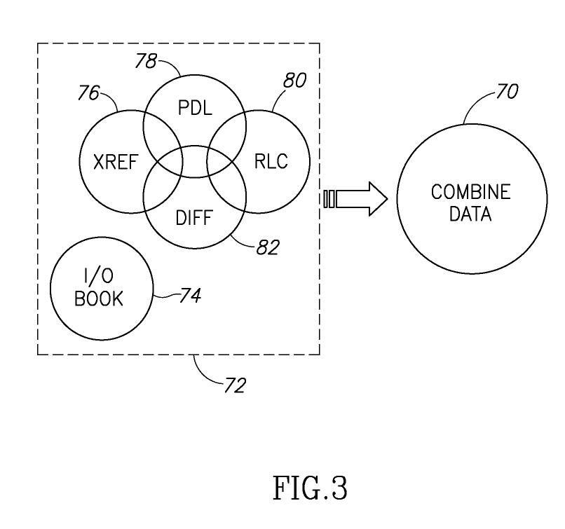

A diagram illustrating the combining of a plurality of technology to yield a combined format file in accordance with the present invention is shown in FIG. 3. The system and method of the present invention is operative to create an assignment information database having a new combined format. The CAD tool of the present invention is operative to input and parse a plurality of different types of files to create a unified assignment information database. The various types of data normally used in the I/O pin assignment process, generally referenced 72, is read and parsed by the system and include: I/O book data 74, Differential IO placement locations (DIFF) data 82 image/package cross reference file (Xref) data 76, Physical Design (PDL) data 78 and Resistance, Inductance, Capacitance (RLC) data 80. The placement and validation system functions to place all relevant information for ASIC I/O assignment in a single database 70.

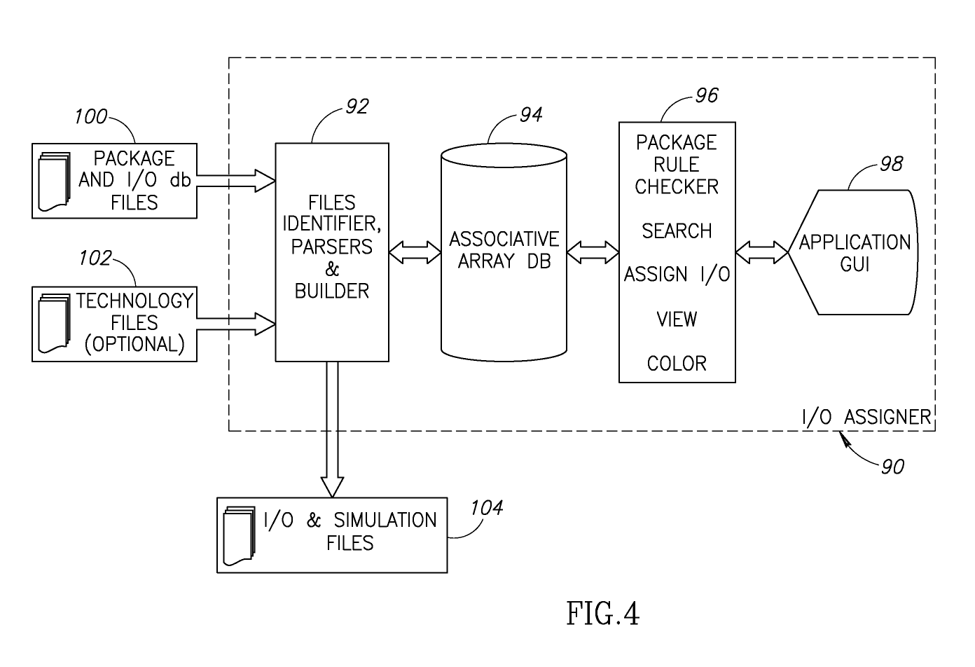

A block diagram illustrating an example embodiment of the I/O pin placement and validation tool of the present invention is shown in FIG. 4. The placement and validation tool 90 comprises a file identifier, parser and database builder module 92, associative I/O assignment information database 94, processing module 96 for performing package rule checks, search I/O pin assignments, package pin viewing and pin colorizing and an application graphical user interface (GUI) 98.

In operation, the tool loads vendor files that describe the ASIC I/Os. The file parsers function to update the single associative I/O assignment information database. A user uses the GUI engine of the tool to update this associative I/O assignment information database after any new assignment or changes to assignments are checked by the package rule checker to prevent package violations. The tool provides a user with capabilities such as search, flip, zoom, multi IO assignment, change color theme, chip die view, etc. to achieve fast assignment of package I/Os. Users can save their work as well. The tool also is able to generate an analog simulation model.

The placement and validation tool can be written in any desired software programming language. As an example the tool can be written in the Tcl/Tk programming language but can also be written in numerous other programming languages as well. Further, the application can be wrapped as an executable application for execution on any desired operating system such as Win, AIX, Linux and Sun.

The placement and validation tool is capable of assigning I/O pins of an IC from scratch or a user can generate a chip view using standard inputs from the user such as size, array, pitch, technology, etc. The design tool can read numerous types of files such as IOSpecList, Xref, PDL, and IFS files and build a chip view for I/O assignment therefrom. It is appreciated by one skilled in the art that the structure of the associative I/O assignment information database used herein can easily assimilate any additional file format as long as it is in text format.

The placement and validation tool enables a customer to begin the ASIC design flow immediately after signing the contract with a vendor. The tool helps a user assign the chip I/Os. More specifically, the tool can assign a single I/O or multiple groups of I/Os using a user friendly GUI which reduces the need to have knowledge of specialist keywords. Further, the tool has search, zoom, print and statistics options. It can display the chip I/Os in various ways such as by group name, technology, direction or RLC. Once the assignment process is complete, the output IOSpecList file used for FEP work is generated. The application can also generate simulation files and IO plan file for simulation environments such as HSpice, IBIS and package design tool.

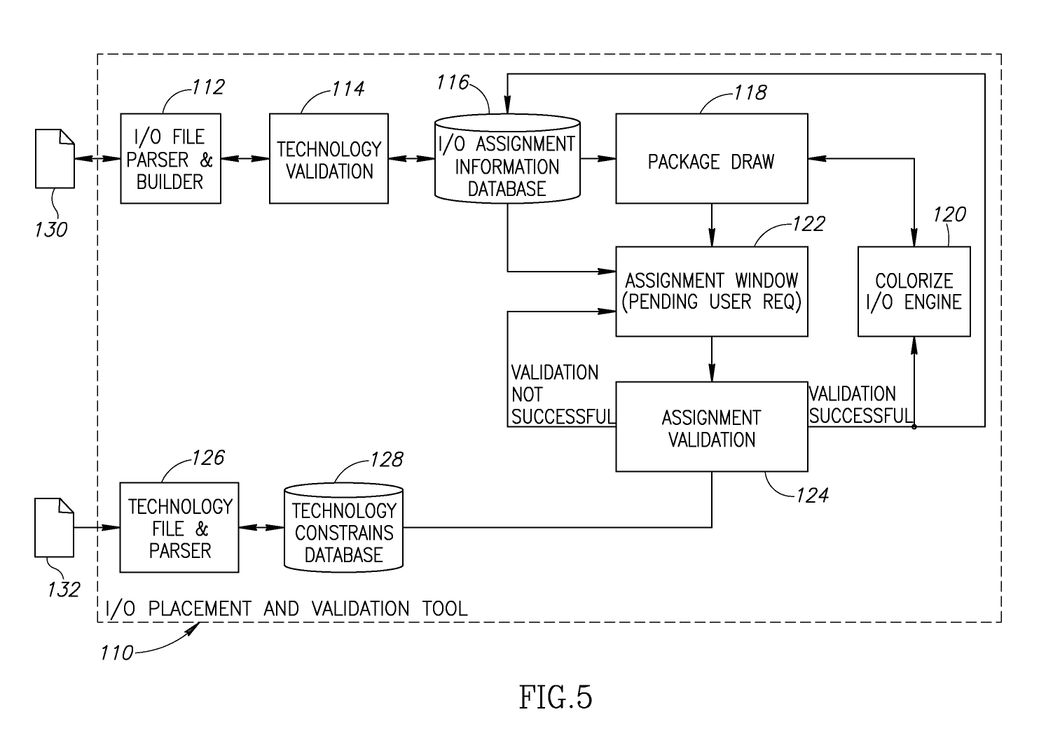

A flow diagram illustrating the basic flow of the ASIC I/O pin placement and validation tool of the present invention is shown in FIG. 5. The I/O placement and validation tool, generally referenced 110, comprises an I/O file parser and builder 112, technology validation module 114, I/O assignment information database 116, package draw module 118, colorize I/O engine 120, assignment window module 122, assignment validation module 124, technology file parser 126 and technology constraints database 128.

In operation, the I/O file parser procedure 112 parses a plurality of input files 130 comprising IC design, technology and package related information. The technology file parser 126 parses one or more input technology files 132. The I/O file parser can also read assignment file previously written by the software tool. Specifically, the I/O file parser identifies the name package pin location and the die location (C4 or I/O slot) of each pin. The data is then transferred to the technology validation procedure 114 which is operative to check the validity of the data. The data, once validated, is stored in the I/O assignment information database 116.

The package draw module 118 functions to draw the chip view based on information extracted from the I/O assignment information database. When a user opens the assignment window 122 from the GUI menu, the software tool retrieves the information corresponding to the pin selected by the user from the I/O assignment information database. Note that the assignment window is a dynamic window and the package draw module is operative to dynamically change the image drawn in accordance with (1) the data stored in the I/O assignment information database and (2) the user's selection. When the user enters new data into the window, the software tool checks to see if the data is valid 124 utilizing the technology constraints database 128 which is built by the technology file parser 126. After the user completes the assignment procedure, the data is written back to the I/O assignment information database and the package view is redrawn based on the new data assigned.

The colorize I/O engine 120 functions to assign colors to the different types of pins. The user has the ability to control the color coding of the pin assignment currently being performed. The I/O file parser and builder module 112 is a bidirectional unit which is adapted to both parse the input I/O file and to rebuild the I/O file after I/O pin assignment is complete. The parsing methodology functions to identify the file type and parse the appropriate data into the I/O assignment information database.

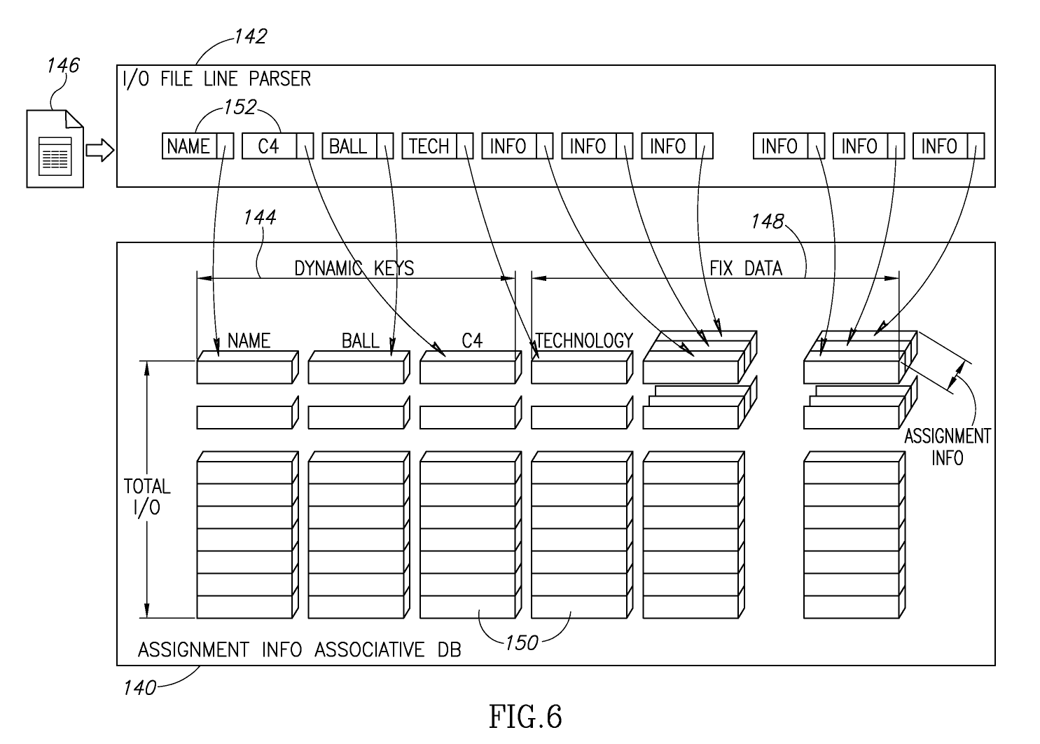

A digram illustrating the structure of the assignment information database in more detail is shown in FIG. 6. The assignment information database, generally referenced 140, is constructed from data items 150 that may comprise three types of keys 144 and fixed data 148. The three keys include: (1) the coordination of the package pin (Ball), (2) coordination of the solder bump (C4 or I/O Slot) and (3) the name of the pin (Name). Each of the keys is unique and is not allowed to appear twice in the database. The I/O file parser 142 functions to extract the data 152 from the I/O file 146 and store it in the database. The flexibility of having three types of keys permits the placement and validation tool of the present invention to read, parse and assimilate several different types of I/O files into a single database. When building an I/O file the user can choose which data to place in the output I/O file. Thus the tool provides flexibility in choosing the format of the final output I/O file.

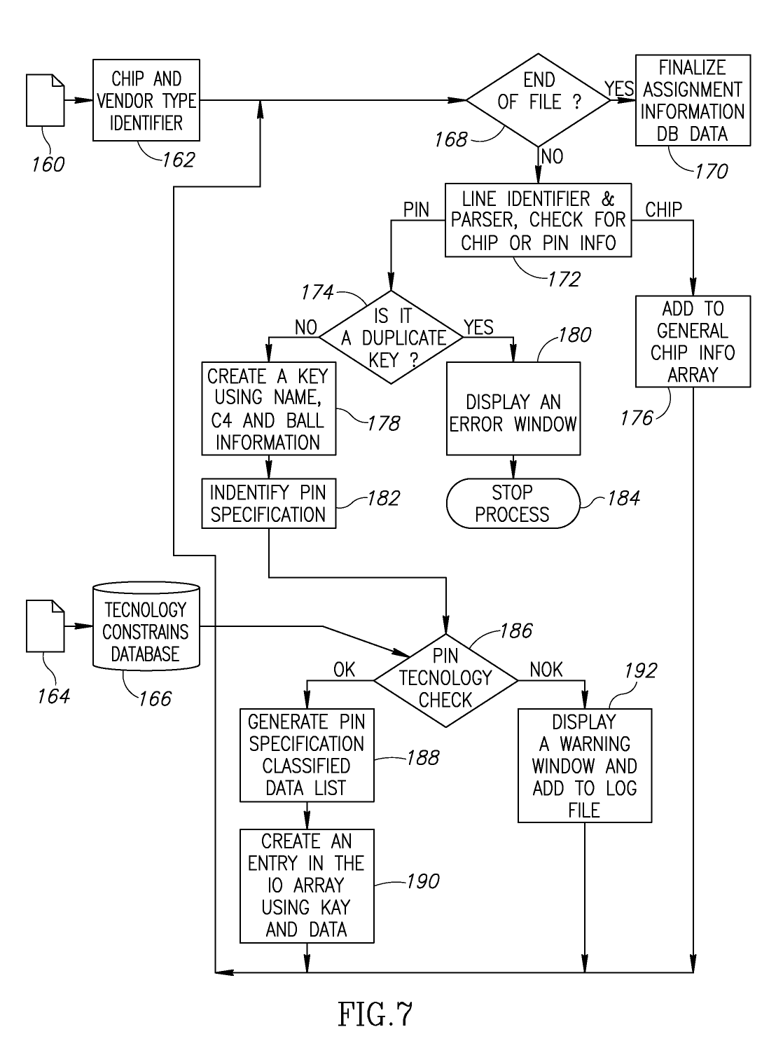

A flow diagram illustrating the I/O file parsing process portion of the I/O pin placement and validation tool of the present invention in more detail is shown in FIG. 7. The I/O file parsing process opens the I/O file 160 and parses it (step 172) line by line till the end of the file is reached (step 168). The parsing algorithm is adapted to identify general keywords which describe the chip package or image and store them in a separate database referred to as a general information array or database (step 176). These keywords are written to the output file at a later time.

Once the parser identifies pin data it creates an entry in the assignment information database (step 178) as shown in FIG. 6. If the parser identifies duplicity, in the keys (step 174) it alerts the user (step 180) and stops the process (step 184). Note that duplicate keys occur when there is an incompatibility between the data in the I/O file. When this happens, the information on which line caused the problem is provided to the user. This user then has an opportunity, to fix the problem and reload the file.

The parser receives the technology information 164 from the technology constraints data base 166 and validates the accuracy of the incoming data (step 186). If the data is invalid, the parser displays a warning message and writes the problem to a log file (step 192). The parser will not write any data into the assignment information database. Rather the parser keeps the key in place to enable the user to insert correct data later on in the process.

Once the data is validated and found to be correct, the parser generates a classified data list (step 188) to be entered into the assignment information database. Each list in the database accumulates information which has a common ground such as system connection, test connection, de-cap info, x-y info, etc. Each list comprises one or more entries depending on the data. If the list already exists the data is appended to the common ground list. Once the list is ready, the data is stored in the assignment information database (step 190). The process continues until the end of the I/O file is reached. Once the end of the I/O file is reached, the parser finalizes the assignment information database and the data is available for use by other processes within the placement and validation tool (step 170).

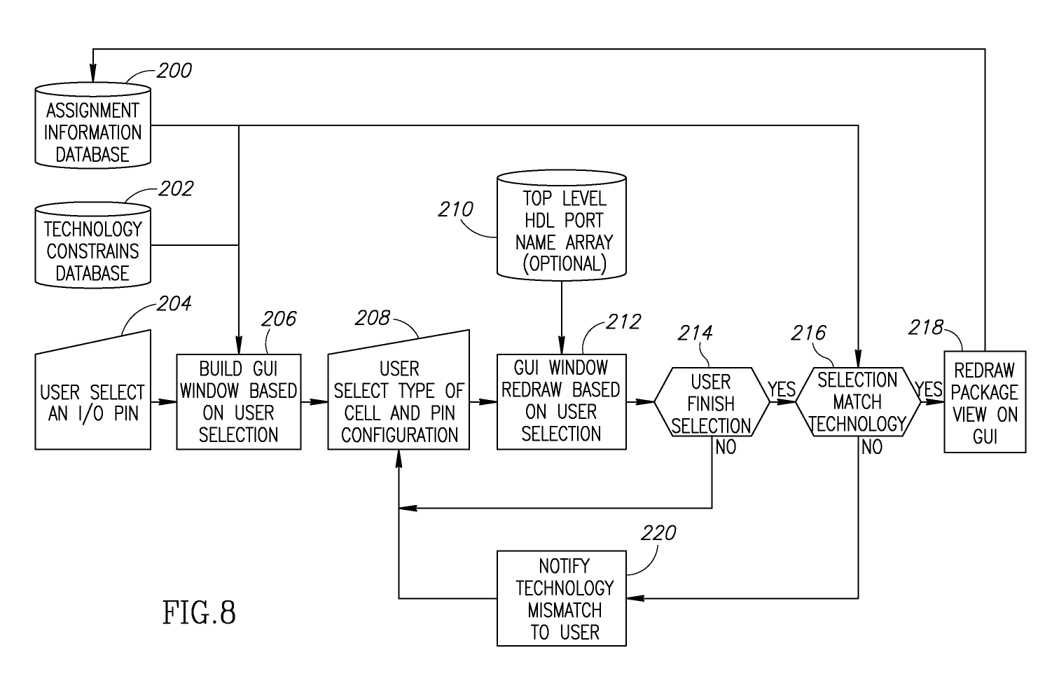

A flow diagram illustrating the I/O assignment window process portion of the I/O pin placement and validation tool as implemented in a software application is shown in FIG. 8. The placement and validation tool is operative to build a GUI window 206 for displaying the chip pin view based on the current contents of the assignment information database keys 200 and technology constraints database 202 and on the user I/O pin selection 204. Each pin is colored based on the color coding the selected by the user. The tool comprises an integrated shell window which displays messages and allows the user to fun the tool commands via the command line. By pressing the left mouse button on a pin, the tool displays the pin information as recorded in the assignment information database. Pressing the right button on a pin opens the assignment window which then receives and displays information on the selected pin or group of pins.

The tool builds the window fields based on latest data retrieved from the assignment information database 200 and technology constraints database 202. For each selected I/O pin, the user selects the type cell and pin configuration 208. The fields of the assignment window change dynamically based on the user's selection. For example, if the user defined the pin to be input only, only the system input fields will be available to the user. Similarly, if the user chooses the pin to be functional only, all test specific fields will be unavailable for editing. Fields with predefined values are presented in a drop box menu format with predefined values. The user has an option to read the chip top level hardware description language (HDL). Once the HDL code is loaded, the user has the option to open an additional window containing the list of ports from the HDL code. Selecting the port places the port name in the appropriate entry. In one example embodiment, the port name in the list is colored (e.g., green) to identify assigned and unassigned ports.

The GUI window is then redrawn (step 212) based on the user's selection. After the user finishes the assignment of the selected I/O pin (step 214), the assignment window checks if all the necessary fields were filled up and validates the data against the technology constraints (step 216). If the data does not pass validation, the user is alerted and the fault fields are highlighted in red (step 220). Once the user data passed the technology, validation step, the data is then transferred to the GUI engine which redraws the chip image based on the new user provided data (step 218). The assignment information database is then updated with the new user provided data.

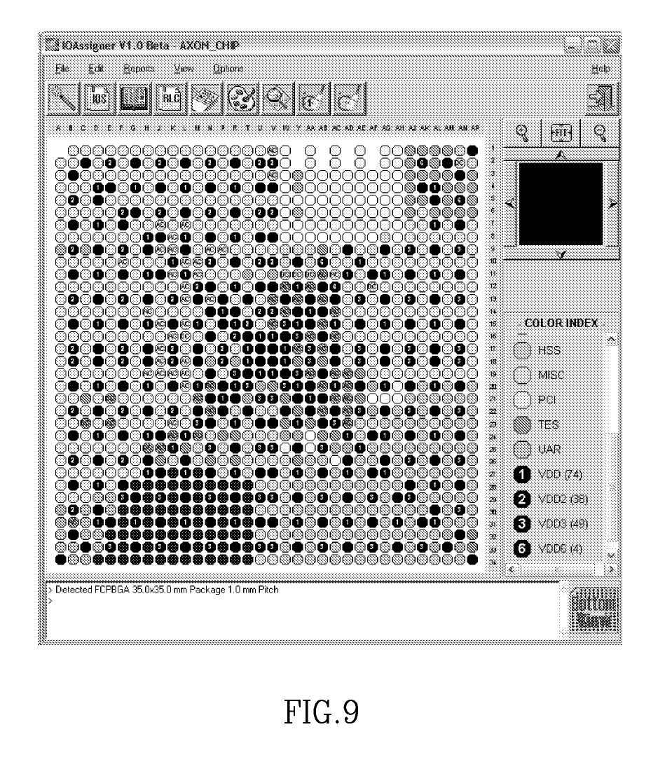

An example screen shot of the GUI portion of an exemplary embodiment of the I/O pin placement and validation tool is shown in FIG. 9. The example package pin image shows the current assignment of each pin in the package. Each is color coded with the color index provided on the right hand side. Users perform actions by choosing from the drop down menu bar and the tool bar at the top of the window or by selection of the pin in the GUI. A command line and message window is provided at the bottom along with a bottom view of the IC package.

There are four methods of assignment provided by the tool. The first is a ‘single ended’ pin assignment which assigns the data to a single package pin. The second is a ‘differential’ pin assignment whereby the user selects either a set of two differential pins or a positive pin only. In this case, the tool automatically selects the best suitable and unassigned negative pin using the technology information available in the I/O related data and technology constraints databases. The third and fourth methods are similar to the first and second, respectively, but for multiple pins and not a single set of pins. The user can select a group of pins to be assigned as single ended or differential using the mouse button. Alternatively, the user can submit the number of pins and the tool is operative to find the best appropriate location depending on the technology guidelines and constraints and on pin availability. The user confirms the location prior to the actual assignment procedure. Once the location is confirmed, the user can browse between the selected pins inside the assignment window.

As a result of the structure used to construct the assignment information database, the coloring engine is capable of coloring the chip package view using a number of various templates. The user selects via the GUI which template to color with. In response thereto, the tool then goes through the assignment information database and assigns each pin the color coding selected by the template. Examples of common templates include: name prefix, IO book type, direction, voltage regions, system assign pins, RLC values, de-cap placed, chip test pins, etc.

The tool also comprises a search engine, the search engine being adapted to search the assignment information database, including the database keys and data. The user specifies which type of data to search (wild cards are supported) and the search engine the package pins that match the search criteria. The user then has the option to automatically select them for assignment.

The GUI is operative to display a view of the chip including an upper (live-chip) and bottom (dead-chip) view of the package. In addition, zoom capabilities are provided in order to facilitate the I/O placement procedure. To validate correct C4 or I/O slot locations the tool displays the C4 or I/O slot location and a point-to-point connection between the C4 or I/O slot and package pin.

The tool displays and saves chip statistics, analog models (depending on the availability of core I/O models from the vendor) and the I/O files (in various formats). The sets of files generated provide validated I/O data that can significantly shorten the design time and eliminate technology failures in subsequent chip design stages. The tool can also save the package view and board design files for use by the board design team and system architect.

In alternative embodiments, the methods of the present invention may be applicable to implementations of the invention in integrated circuits, field programmable gate arrays (FPGAs), chip sets or application specific integrated circuits (ASICs), DSP circuits wireless implementations and other communication system products.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of placing and validating input/output (I/O) pins in an integrated circuit (IC), said method comprising the steps of:
receiving IC related data including technology constraints and package and pin data;
parsing said IC related data and building an I/O assignment information database therefrom;
building a dynamic graphical view of package pins based on the contents of said I/O assignment information database; and
validating pin assignments received from a user against said technology constraints; and
updating said I/O assignment information database in accordance therewith.

2. The method in accordance with claim 1, further comprising the step of redrawing said graphical view of said package pins after a pin assignment received from a user is successfully validated.

3. The method in accordance with claim 1, wherein said IC related data comprises IC design, technology and package related information.

4. The method in accordance with claim 1, further comprising the step of writing the contents of said I/O assignment information database to an I/O file effectively combining said IC related data in a single file.

5. The method in accordance with claim 1, further comprising the step of assigning colors to said IC pins in accordance with a user color coding selection.

6. A computer program product, comprising:
a computer usable medium having computer usable program code for placing and validating input/output (I/O) pins in an integrated circuit (IC), said computer program product including;
computer usable program code for receiving IC related data including technology constraints and package and pin data;
computer usable program code for parsing said IC related data and building an I/O assignment information database therefrom;
computer usable program code for building a dynamic graphical view of package pins based on the contents of said I/O assignment information database; and
computer usable program code for validating pin assignments received from a user against said technology constraints; and
updating said I/O assignment information database in accordance therewith.

7. The computer program product in accordance with claim 6, further comprising the step of redrawing said graphical view of said package pins after a pin assignment received from a user is successfully validated.

8. The computer program product in accordance with claim 6, wherein said IC related data comprises IC design, technology and package related information.

9. The computer program product in accordance with claim 6, further comprising the step of writing the contents of said I/O assignment information database to an I/O the effectively combining said IC related data in a single file.

10. The computer program product in accordance with claim 6, further comprising the step of assigning colors to said IC pins in accordance with a user color coding selection.

11. A method of placing and validating input/output (I/O) pins in an integrated circuit (IC), said method comprising the steps of:
receiving package and I/O related data associated with an IC;
receiving a set of technology constraints associated with said IC;
parsing said IC package and I/O related data and said set of technology constraints and building an I/O assignment information database in accordance therewith;
building a dynamic graphical view of package pins based on the contents of said I/O assignment information database:
optimizing the placement of one or more user selected pins;
validating pin assignments against said technology constraints;
updating said I/O assignment information database in accordance therewith: and
redrawing said packet view in accordance with the contents of said updated I/O assignment information database.

12. The method in accordance with claim 11, wherein access to the contents of said I/O assignment information database is controlled via a pin name key, package pin coordination key and controlled collapse chip connection (C4) key.

13. The method in accordance with claim 11, further comprising the step of storing non-pin related IC information in a general information array.

14. The method in accordance with claim 11, further comprising the step of within the contents of said I/O assignment information database to an I/O file effectively combining said IC related data in a single file.

15. The method in accordance with claim 11, further comprising the step of assigning colors to said IC pins in accordance with a user color coding selection.

16. A computer program product comprising:
a computer usable medium having computer usable programs code for placing and validating input/output (I/O) pins in an integrated circuit (IC), said computer program product including:
computer usable program code for receiving package and I/O related data associated with an IC;
computer usable program code for receiving a set of technology constraints associated with said IC;
computer usable program code for parsing said IC package and I/O related data and said set of technology constraints and building an I/O assignment information database in accordance therewith;
computer usable program code for building a dynamic graphical view of package pins based on the contents of said I/O assignment information database;
computer usable program code for optimizing the placement of one or more user selected pins;
computer usable program code for validating pin assignments against said technology constraints;
updating said I/O assignment information database in accordance therewith; and
computer usable program code for redrawing said packet view in accordance with the contents of said updated I/O assignment information database.

17. The computer program product in accordance with claim 16, wherein access to the contents of said I/O assignment information database is controlled via a pin name key, package pin coordination key and controlled collapse chip connection (C4) key.

18. The computer program product in accordance with claim 16, further comprising the step of storing non-pin related I/O information in a general information array.

19. The computer program product in accordance with claim 16, further comprising the step of writing the contents of said I/O assignment information database to an I/O file effectively combining said IC related data in a single file.

20. The computer program product in accordance with claim 16, further comprising the step of assigning colors to said IC pins in accordance with a user color coding selection.
